(19) United States
(12) Patent Application Publication
(10) Pub. No.: US 2015/0244799 A1
(43) Pub. Date: Aug. 27, 2015

(54) DISPLAY SYSTEM, DISPLAY APPARATUS, DISPLAY METHOD, AND COMPUTER PROGRAM

(71) Applicant: SEIKO EPSON CORPORATION, Tokyo (JP)

(72) Inventors: Akio YAMAZAKI, Shiojiri-shi (JP); Ikuo HAYAISHI, Asahi-mura (JP)

(21) Appl. No.: 14/626,680

(22) Filed: Feb. 19, 2015

(30) Foreign Application Priority Data
Feb. 21, 2014 (JP) 2014-031471

(51) Int. Cl. H04L 29/08; G06F 17/30

(52) U.S. Cl. CPC H04L 67/1095; G06F 17/3089

(57) ABSTRACT

A display apparatus, upon an operation for changing a page of a displayed document being performed, transmits a synchronization instruction including a document filename of the displayed document and a page number after the change to a server apparatus 20. The server apparatus transfers the synchronization instruction transmitted from the display apparatus to other display apparatuses. The other display apparatuses open a document file having the document filename included in the transmitted synchronization instruction, and display an image of the page having the page number included in the synchronization instruction.

### BACKGROUND

1. Technical Field

The present invention relates to a display system, a display apparatus, and a computer program.

2. Related Art

Inventions for displaying the same screen on two computers include an invention disclosed in JP-A-2000-29861, for example. In this invention, operation information that is based on an operation performed on a teacher terminal is transmitted to a student terminal via a network. The student terminal, upon receiving the operation information transmitted by the teacher terminal, reproduces the received operation information. For example, in the case where a mouse is moved on the teacher terminal, operation information including the coordinates of the mouse and showing the movement of the mouse is transmitted from the teacher terminal to the student terminal. The student terminal, upon receiving the transmitted operation information, moves the mouse cursor to the coordinates included in the operation information. Also, when, in the case where there are a plurality of student terminals, operation information is transmitted from a student terminal to the teacher terminal, the operation information is reproduced on the teacher terminal, and the screen of the student terminal that transmitted the operation information is displayed on the teacher terminal.

Incidentally, in the invention of JP-A-2000-29861, the transmission destination of the operation information is only one terminal. Thus, when the teacher terminal transmits operation information in the case where there are a plurality of student terminals to one teacher terminal, for example, the screen of the teacher terminal can only be seen on one of the plurality of the student terminals. Also, in the case where a student terminal transmits operation information, the operation information is transmitted to the teacher terminal but not to the other student terminals, and thus even though the screen of the student terminal that transmitted the operation information is displayed on the teacher terminal, the screen of the student terminal that transmitted the operation information cannot be seen on the other student terminals.

### SUMMARY

An advantage of some aspects of the invention is to synchronize the display of a plurality of apparatuses with the display of one apparatus.

A display system according to an aspect of the invention includes a server apparatus and a plurality of display apparatuses. Each of the plurality of display apparatuses includes a display unit that displays an image, a storage unit that stores a document, a transmission unit that transmits a synchronization instruction including an identifier of a document that is displayed on the display unit to the server apparatus, a reception unit that receives a synchronization instruction transmitted from the server apparatus, and a display control unit that acquires, from the storage unit, a document that is specified by an identifier included in the synchronization instruction received by the reception unit, and controls the display unit such the acquired document is displayed. Also, the server apparatus includes a transfer unit that receives the synchronization instruction transmitted from the transmission unit, and transmits the received synchronization instruction to at least display apparatuses other than the display apparatus that transmitted the synchronization instruction.

According to this configuration, the display of a plurality of display apparatuses can be synchronized with the display of one display apparatus.

Also, in the invention, a configuration may be adopted in which the synchronization instruction includes an apparatus identifier that identifies the plurality of display apparatuses, and the display control unit does not control the display unit, in a case where the apparatus identifier included in the synchronization instruction received by the reception unit is the apparatus identifier of the display apparatus in which the display control unit is included.

According to this configuration, it is possible to ensure that a display apparatus that transmits a synchronization instruction does not update display with the synchronization instruction that the display apparatus itself transmitted.

Also, in the invention, a configuration may be adopted in which the server apparatus includes a specification unit that requests the plurality of display apparatuses for a response, and specifies a display apparatus that returns a response to the request, and the transfer unit transmits the synchronization instruction to the display apparatus specified by the specification unit.

According to this configuration, the display of a display apparatus that is capable of communicating with the server apparatus in the display system can be synchronized.

Also, in the invention, a configuration may be adopted in which the display apparatus includes a detection unit that detects coordinates indicated by an indicator that indicates coordinates on a display surface of the display unit, the transmission unit transmits a synchronization instruction including the coordinates detected by the detection unit to the server apparatus, and the display control unit controls the display such that a line generated based on the coordinates included in the synchronization instruction is displayed.

According to this configuration, an image corresponding to the movement locus of an indicator in one display apparatus can be displayed on the display unit.

Also, in the invention, a configuration may be adopted in which the synchronization instruction includes the coordinates for one stroke of the indicator.

According to this configuration, an image corresponding to each stroke of an indicator in one display apparatus can be displayed in another display apparatus.

Also, in the invention, a configuration may be adopted in which the synchronization instruction includes information showing a start of one stroke or information showing an end of one stroke, and the display control unit controls the display such that a line connecting the coordinates included in the synchronization instruction is displayed, based on the synchronization instruction including the information showing the start of one stroke, the synchronization instruction received by the reception unit after the synchronization instruction showing the start of one stroke, and the synchronization instruction including the information showing the end of one stroke.

According to this configuration, an image corresponding to the movement locus of an indicator on one remote display apparatus can be promptly displayed in another display apparatus, according to the movement of the indicator.

Also, in the invention, a configuration may be adopted in which the transmission unit transmits a synchronization instruction including object data showing an object to be displayed on the display unit, and the display control unit controls the display such that an image of the object that is shown by the object data included in the synchronization instruction is displayed.

According to this configuration, an image of an object included in a document displayed in one display apparatus can be displayed in another display apparatus.

Also, in the invention, a configuration may be adopted in which the transmission unit transmits a synchronization instruction including a page number of the document, and the display control unit controls the display such that a page having the page number included in the synchronization instruction, out of the acquired document, is displayed.

According to this configuration, the same page as the page of a document currently displayed in one display apparatus can be displayed in another display apparatus.

Also, in the invention, a configuration may be adopted in which the display control unit is an application, the synchronization instruction includes identification information showing the application, and the synchronization instruction that is received by the reception unit is sent to the application corresponding to the identification information included in the synchronization instruction via an operating system.

According to this configuration, even when there are a plurality of applications in the display apparatus, a synchronization instruction can be sent to an application that performs image display.

Also, in the invention, a configuration may be adopted in which the synchronization instruction including the coordinates that is received by the reception unit is sent to the display control unit without passing via an operating system.

According to this configuration, the time taken to complete synchronization can be shortened, since the synchronization instruction is sent without passing via the operating system.

Also, a display apparatus according to an aspect of the invention includes a display unit that displays an image, a storage unit that stores a document, a transmission unit that transmits a synchronization instruction including an identifier of a document that is displayed on the display unit to a server apparatus, a reception unit that receives a synchronization instruction transmitted from the server apparatus, and a display control unit that acquires, from the storage unit, a document that is specified by an identifier included in the synchronization instruction received by the reception unit, and controls the display unit such the acquired document is displayed.

According to this configuration, the display of one display apparatus can be synchronized with the display of a plurality of other display apparatuses.

Also, a computer program according to an aspect of the invention is for causing a computer to execute a transmission step of transmitting a synchronization instruction including an identifier of a document that is displayed on a display unit to a server apparatus, a reception step of receiving a synchronization instruction transmitted from the server apparatus, and a transfer step of sending the synchronization instruction to an application that is specified by identification information included in the synchronization instruction received in the reception step.

According to this configuration, the display of one display apparatus can be synchronized with the display of a plurality of other display apparatuses.

### BRIEF DESCRIPTION OF THE DRAWINGS

The invention will be described with reference to the accompanying drawings, wherein like numbers reference like elements.

FIG. 1 shows apparatuses constituting a display system 1 according to an embodiment of the invention.

FIG. 2 is a block diagram showing the hardware configuration of display apparatuses 10A to 10C.

FIG. 3 is a block diagram showing the configuration of software in the display apparatuses 10A to 10C.

FIG. 4 shows the hardware configuration of a server apparatus 20.

FIG. 5 shows the configuration of functions that are realized in the server apparatus 20.

FIG. 6 shows an exemplary screen that is displayed on a display unit 107.

FIG. 7 is a flowchart showing the flow of processing that is performed by a second application 1200.

FIG. 8 is a flowchart showing the flow of processing that is performed by the second application 1200.

FIG. 9 shows an exemplary screen that is displayed on the display unit 107.

FIG. 10 is a flowchart showing the flow of processing that is performed by the second application 1200.

FIG. 11 is a flowchart showing the flow of processing that is performed by the second application 1200.

FIG. 12 shows the configuration of functions that are realized in the server apparatus 20 according to a modification.

### DESCRIPTION OF EXEMPLARY EMBODIMENTS

### Embodiments

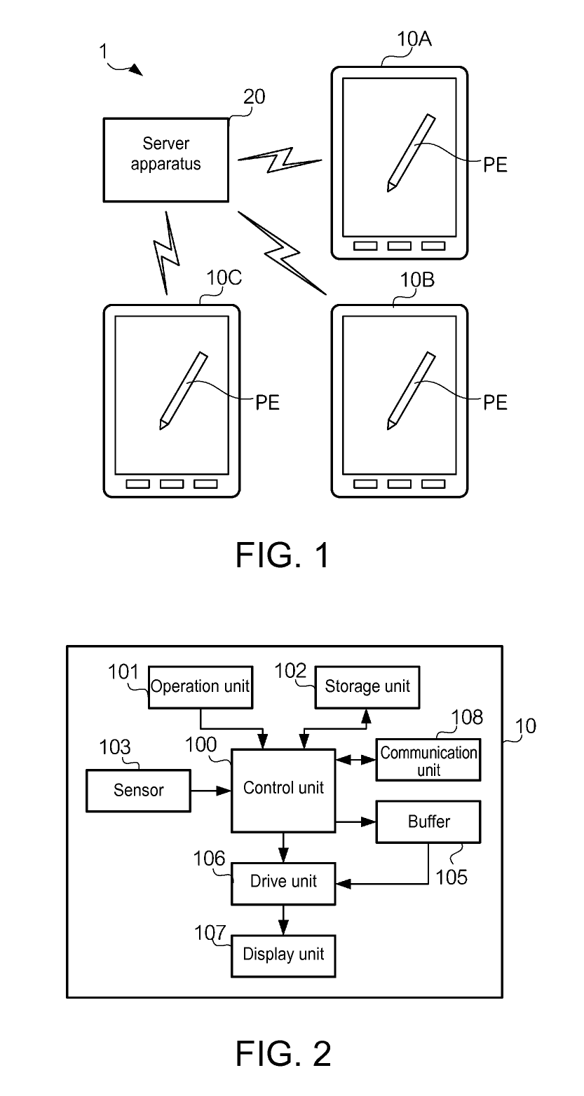

FIG. 1 shows apparatuses constituting a display system 1 according to one embodiment of the invention. Display apparatuses 10A to 10C are apparatuses that have electrophoretic electronic paper as the display device, and display documents shown by document files. Also, a stylus pen PE is an example of an indicator that indicates coordinates on a display surface of the electronic paper. The display apparatuses 10A to 10C have respectively the same configuration, and, hereinafter, will thus be denoted as “display apparatus 10” in the case where it is not necessary to distinguish between the individual display apparatuses. Note that although the display apparatuses 10A to 10C are included in the display system 1 in the present embodiment, the display system 1 may be configured to include four or more display apparatuses 10.

The display apparatus 10 has a sensor that detects, at a predetermined period, the coordinates where the stylus pen PE contacts the display surface of the electronic paper, and when the user moves the stylus pen PE in contact with the display surface, the coordinates on the display surface where the stylus pen PE is in contact are detected by the sensor. In the case where one of icons for executing various processing are displayed at the detected position of the stylus pen PE, the display apparatus 10 executes processing according to the icon that is displayed at the detected position.

A server apparatus 20 is an apparatus for transferring various instructions sent from a display apparatus 10 to display apparatuses 10 that are included in the display system 1, and transfers instructions transmitted from the display apparatus 10A to the display apparatus 10B, and transfers instructions transmitted from the display apparatus 10B to the display apparatus 10A.

### Configuration of Display Apparatus 10

FIG. 2 shows a hardware configuration of the display apparatus 10. A display unit 107 is electrophoretic electronic paper in which pixels are arrayed in a plurality of rows and columns, and displays a multi-level monochrome image. The display unit 107 is an exemplary display device that holds the image that is displayed even when power is not supplied, that is, an exemplary display device provided with a display area having memory. Note that the display unit 107 may be electronic paper using quick response liquid powder display (QR-LPD®) technology. Also, the display unit 107 is not limited to electronic paper, and may be a liquid crystal display or an organic electroluminescence display.

A buffer 105 is a memory that stores image data showing an image to be displayed on the display unit 107. The buffer 105 has a storage area that stores, for each pixel of the display unit 107, a gradation value of the pixel. Image data representing the gradation value of each pixel is written to the storage area of the pixel by a control unit 100. A drive unit 106 has a drive circuit that drives the display unit 107. The drive unit 106 acquires the image data of the gradation values stored in the buffer 105, and drives the pixels of the display unit 107 based on the acquired image data.

A storage unit 102 has a nonvolatile memory and stores document files. In the present embodiment, the document files are in portable document format (PDF) according to which the document is divided into pages, but the document file format is not limited to PDF and may be another format. Also, the storage unit 102 stores an application program (hereinafter, “second application”) that displays documents that are represented by document files, and an application program (hereinafter, “first application”) that synchronizes the display of the display unit 107 with another display apparatus 10 other than the display apparatus 10 in which the display unit 107 is included.

An operation unit 101 has a plurality of buttons for operating the display apparatus 10. A communication unit 108 is a communication interface that performs wireless communication. The communication unit 108 performs communication in conformity with wireless LAN (Local Area Network) communication standards, and performs transmission of information to the server apparatus 20 and reception of information transmitted from the server apparatus 20.

A sensor 103 is a planar sensor that detects the coordinates where the stylus pen PE contacts the display surface with an electromagnetic induction system. The sensor 103 functions as a detection unit that detects the coordinates where the stylus pen PE contacts the display surface. Note that the display apparatus 10 may be configured to detect the coordinates where the stylus pen PE contacts the display surface with another system such as an electrostatic capacitance system. In the case of employing an electrostatic capacitance sensor, a person's finger also serves as an indicator that indicates coordinates on the display surface. The sensor 103 detects, at a predetermined period, whether the stylus pen PE is in contact with the display surface and the coordinates on the display surface where the stylus pen PE is in contact, and outputs first data (coordinate data) showing the detected coordinates and second data showing whether or not the stylus pen PE is in contact to the control unit 100.

The control unit 100 is a microcomputer provided with a central processing unit (CPU), a read only memory (ROM), and a random access memory (RAM). When the CPU reads out a program stored in the ROM and executes the read program with the RAM as a work area, the operating system of the display apparatus 10 operates, enabling execution of the application programs.

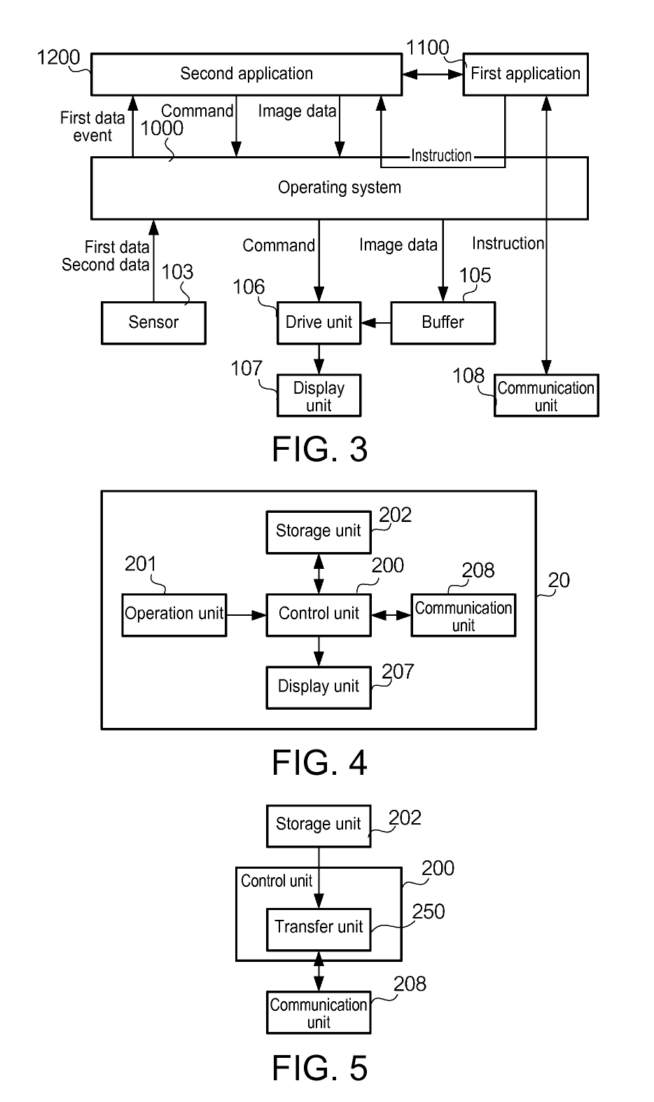

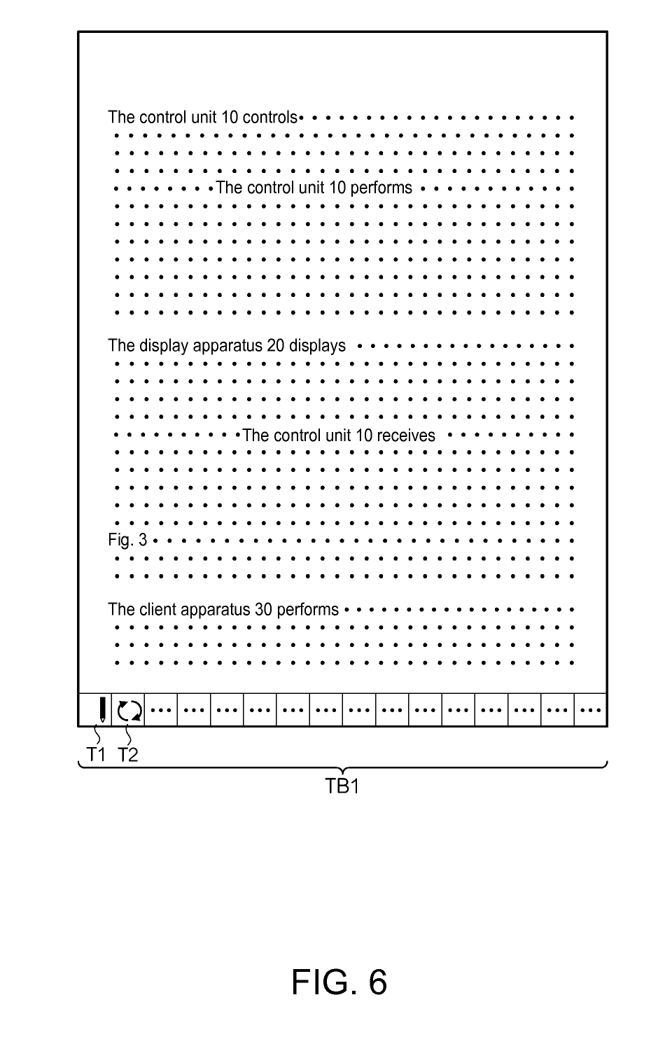

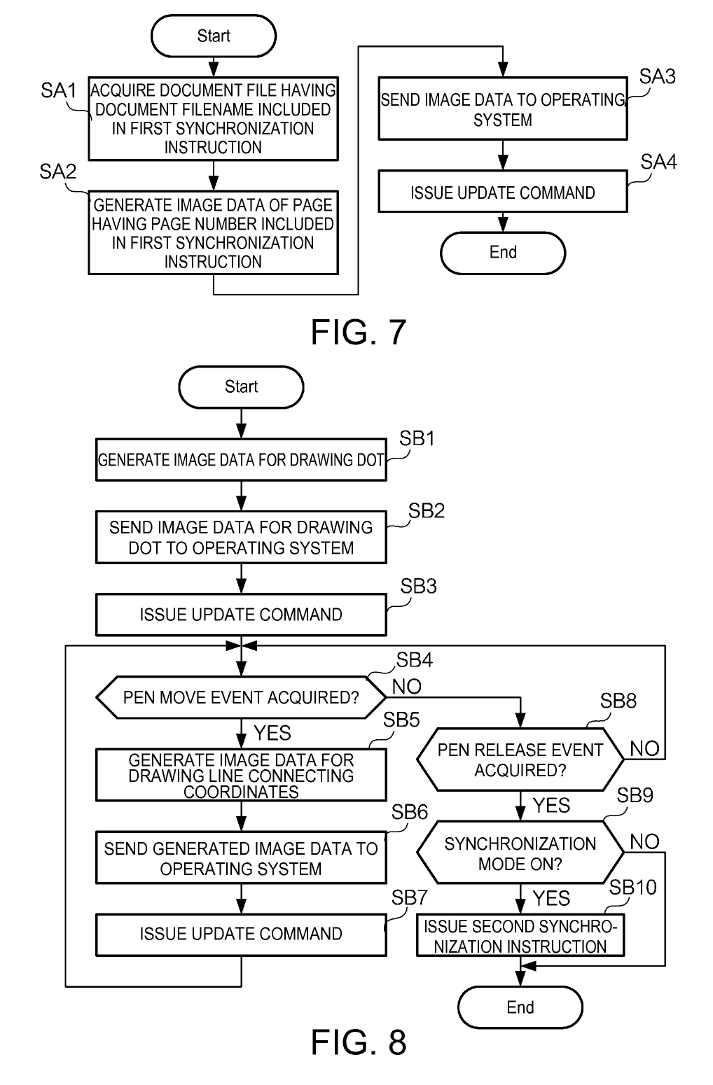

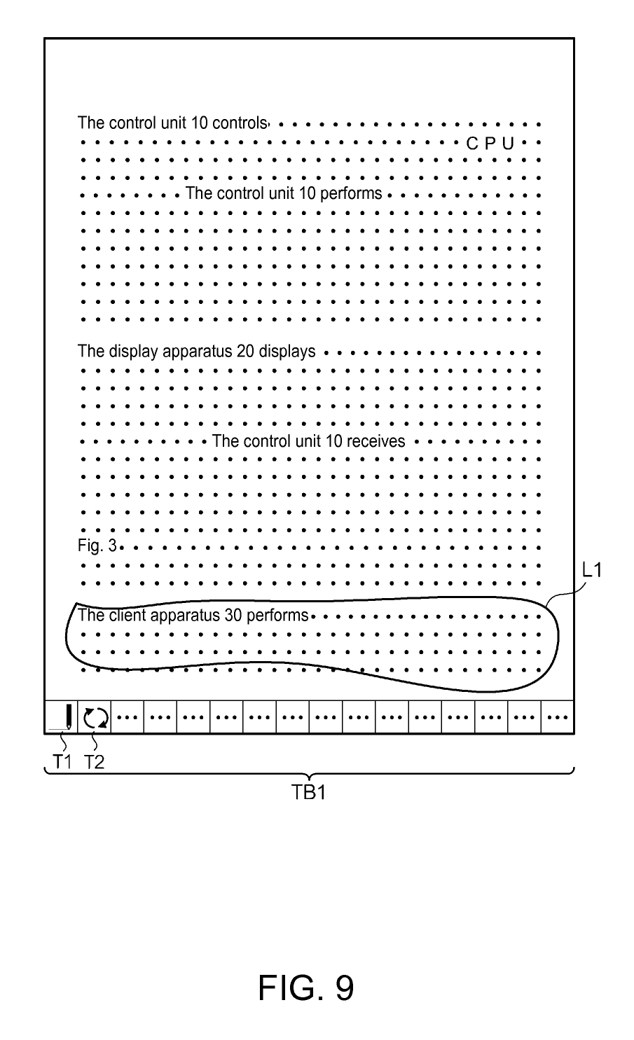

FIG. 3 shows the configuration of software relating to the display apparatus 10. In the present embodiment, an operating system 1000 operates, and the application programs operate on the operating system 1000. The operating system 1000 performs basic processing such as file processing and hardware control. For example, the operating system 1000 acquires the first data and the second data that are supplied from the sensor 103. The operating system 1000 sends the acquired first data to a second application 1200, and an event issued based on the acquired second data to the second application 1200. Specifically, an operating system 1000 issues events relating to operations of the stylus pen PE based on the second data sent from the sensor 103. For example, the operating system 1000, issues a pen touch event notifying that the stylus pen PE is in contact with the display unit 107 in the case where the content of the second data sent from the sensor 103 change from “not in contact” to “in contact”, and issues a pen release event notifying that the stylus pen PE is removed from the display unit 107 in the case where the content of the second data changes from “in contact” to “not in contact”. Also, the operating system 1000 issues a pen move event notifying that the stylus pen PE has moved, in the case where the content of the second data newly sent from the sensor 103 and the content of the second data sent immediately before the newly sent second data are both “in contact”.

Also, the operating system 1000 acquires image data and an image update command sent from the second application 1200. The operating system 1000 writes the acquired image data to the buffer 105, and sends the acquired update command to the drive unit 106. The drive unit 106, upon receiving the update command, acquires the image data from the buffer 105, and controls the display unit 107 based on the acquired image data. Also, the operating system 1000 sends instructions sent from a first application 1100 to the server apparatus 20 via the communication unit 108, and sends instructions sent from the server apparatus 20 and received by the communication unit 108 to the first application 1100. Also, the operating system 1000 sends instructions sent from the first application 1100 to the second application 1200.

The first application 1100 is an application program that executes processing for synchronizing the display of the display apparatus 10 and the display of another display apparatus 10. The first application 1100 functions as a transmission unit that transmits various synchronization instructions which will be discussed later to the server apparatus 20, and also functions as a reception unit that receives various synchronization instructions transmitted from the server apparatus 20. The second application 1200 is an application program having functions that include displaying documents shown by document files stored in the storage unit 102, sending pages of displayed documents, adding handwritten lines to displayed documents, and applying character formatting to the characters of displayed documents. The second application 1200 functions as a display control unit that controls the display unit 107 such that documents that are shown by document files are displayed.

Note that although the display apparatuses 10A to 10C have the same configuration, hereinafter, in the case where the individual elements of the display apparatuses 10A to 10C need to be distinguished from each other, description will be given with “A” appended to the end of the reference sign of each element of the display apparatus 10A, “B” appended to the end of the reference sign of each element of the display apparatus 10B, and “C” appended to the end of the reference sign of each element of the display apparatus 10C for convenience of description.

### Configuration of Server Apparatus 20

FIG. 4 shows a hardware configuration of the server apparatus 20. A communication unit 208 performs communication in accordance with wireless LAN communication standards, and performs transmission of information to and reception of information from the display apparatus 10. A display unit 207 is provided with an apparatus for performing display, and displays character screens, graphics screens and the like under the control of a control unit 200. An operation unit 201 has a keyboard (not shown) and a mouse (not shown) that are operated by a user.

A storage unit 202 has a nonvolatile memory, and stores an application program that executes processing for transferring information sent from a display apparatus 10 to display apparatuses 10 that are included in the display system 1. Also, the storage unit 202 stores a list of apparatus identifiers that identify display apparatuses 10 serving as transfer destinations of instructions transmitted from a display apparatus 10. Note that the apparatus identifiers for identifying the display apparatuses 10 are IP addresses in the present embodiment, but are not limited to IP addresses and may be MAC addresses. In the present embodiment, the IP addresses of the display apparatuses 10A to 10C are included in the list that is stored by the storage unit 202.

The control unit 200 is provided with a CPU, a ROM and a RAM, and controls the storage unit 202, the communication unit 208 and the display unit 207. When the control unit 200 executes the application program stored in the storage unit 202, the function of transferring the instruction sent from a display apparatus 10 to display apparatuses 10 having the identifiers included in the list stored in the storage unit 202 is realized.

FIG. 5 is a block diagram showing the configuration of functions that are realized in the server apparatus 20. A transfer unit 250 receives a synchronization instruction sent from a display apparatus 10, and transfers the received synchronization instruction to the display apparatuses 10 having the identifiers in the list stored in the storage unit 202. The transfer unit 250 acquires the list stored in the storage unit 202. When the communication unit 208 receives an instruction transmitted from a display apparatus 10, the transfer unit 250 acquires the instruction received by the communication unit 208. The transfer unit 250 controls the communication unit 208 to transfer the acquired instruction to the display apparatuses 10 having the identifiers included in the acquired list.

### Exemplary Operations of Embodiment

Next, exemplary operations of the present embodiment will be described. Note that, hereinafter, exemplary operations will be described assuming the case where the same document file is stored in the display apparatuses 10A to 10C, and the IP addresses of the display apparatuses 10A to 10C are stored in the list that is stored in the storage unit 202.

Exemplary Operations when Displaying a Document

When the user of the display apparatus 10A performs an operation for opening the document file stored in the storage unit 102A, the second application 1200A acquires the document file from the storage unit 102A. The second application 1200A generates image data in accordance with the acquired document file, and sends the generated image data to the operating system 1000A. The operating system 1000A writes the image data sent from the second application 1200A to the buffer 105A. Also, the second application 1200A sends an image update command to the operating system 1000A. The operating system 1000A, upon acquiring the update command, sends the acquired update command to the drive unit 106A. When the drive unit 106A receives the update command and drives the display unit 107A based on the data written to the buffer 105A, a document that is shown by the document file is displayed, as illustrated in FIG. 6. Note that a tool bar TB1 for performing various processing on the displayed document is also displayed on the display unit 107A. Icons T1 to T2 for performing various processing are included in the tool bar TB1.

The user of the display apparatus 10A taps the icon T2 with the stylus pen PE, in the case of synchronizing the display of the display apparatuses 10B and 10C with the display of the display apparatus 10A. The second application 1200A sets a synchronization mode to ON when the icon T2 is tapped. Note that upon the icon T2 being tapped when the synchronization mode is ON, the second application 1200A sets the synchronization mode to OFF. The synchronization mode is switched ON and OFF by tapping the icon T2.

The second application 1200A, triggered by the synchronization mode having been set to ON, issues a first synchronization instruction that instructs screen synchronization and includes the IP address of the display apparatus 10A, the document filename of the displayed document and the page number of the displayed document to the first application 1100A. The first application 1100A acquires the first synchronization instruction issued by the second application 1200A, and sends the acquired first synchronization instruction to the operating system 1000A. The operating system 1000A controls the communication unit 108A to transmit the first synchronization instruction sent from the first application 1100A to the server apparatus 20.

When the communication unit 208 receives the first synchronization instruction transmitted from the display apparatus 10A, the transfer unit 250 acquires the first synchronization instruction received by the communication unit 208. In the case where the IP address included in the acquired first synchronization instruction is included in the list stored in the storage unit 202, the transfer unit 250 specifies IP addresses other than the IP address of the display apparatus 10A that transmitted the first synchronization instruction, among the IP addresses included in the list. The transfer unit 250 controls the communication unit 208 and transfers the acquired first synchronization instruction to the display apparatuses 10 having the specified IP addresses. Note that, in these exemplary operations, the first synchronization instruction is transferred to the display apparatuses 10B and 10C.

When the communication unit 108B receives the first synchronization instruction transferred by the server apparatus 20, the operating system 1000B sends the first synchronization instruction received by the communication unit 108B to the first application 1100B. The first application 1100B acquires the first synchronization instruction, and sends the acquired first synchronization instruction to the second application 1200B via the operating system 1000B. Note that in the case where the operating system of the display apparatus 10 is Android®, identification information showing a second application 1200 is included in the first synchronization instruction. The first application 1100B sends the acquired first synchronization instruction to the operating system 1000B by explicit intent, with the second application 1200B that is designated by the identification information included in the first synchronization instruction specified as the destination. The operating system 1000B sends the first synchronization instruction to the second application 1200B designated as the destination by explicit intent. In the case where the second application 1200B that is specified by the identification information has not been executed, the operating system 1000B sends the synchronization instruction to the second application 1200B after executing the second application 1200B. Note that a configuration may be adopted in which the acquired first synchronization instruction is sent to the second application 1200B via the operating system 1000B by implicit intent. The second application 1200B acquires the first synchronization instruction sent from the first application 1100B via the operating system 1000B.

The second application 1200B executes the processing shown in FIG. 7 when the first synchronization instruction is acquired. The second application 1200B, upon acquiring the first synchronization instruction, acquires the document file having the document filename included in the first synchronization instruction from the storage unit 102B (step SA1). The second application 1200B specifies, in the acquired document file, the page having the page number included in the first synchronization instruction, and generates image data of the specified page (step SA2).

The second application 1200B sends the generated image data to the operating system 1000B (step SA3). The operating system 1000B writes the image data sent from the second application 1200B to the buffer 105B. Also, the second application 1200B issues an update command that instructs updating of display (step SA4). The operating system 1000B, upon acquiring the update command, sends the acquired update command to the drive unit 106B. When the drive unit 106B receives the update command and drives the display unit 107B based on the data written to the buffer 105B, the same page as the page displayed in the display apparatus 10A is displayed on the display unit 107B.

Note that similar operations to the display apparatus 10B are also performed in the display apparatus 10C when the communication unit 108C receives the first synchronization instruction, and the same page as the page displayed in the display apparatus 10A is displayed on the display unit 107C.

Exemplary Operations when Adding a Handwritten Line

Next, exemplary operations in the case where the user adds a handwritten line to the displayed document will be described. When the user taps the icon T1 with the stylus pen PE, it becomes possible to add a handwritten line to the displayed document. In a state in which the stylus pen PE is not in contact with the display unit 107A, the sensor 103A outputs second data whose content is “not in contact”. When the user brings the stylus pen PE in contact with the display surface of the display unit 107A, the sensor 103A outputs first data (coordinate data) and second data whose content is “in contact”. The operating system 1000A acquires the first data and the second data output by the sensor 103A. The operating system 1000A, upon acquiring the second data whose content is “in contact”, issues a pen touch event and sends the issued pen touch event and the acquired first data to the second application 1200A, in the case where the content of the second data acquired immediately before the acquired second data is “in not contact”.

The second application 1200A acquires the pen touch event and the first data sent from the operating system 1000A. The second application 1200A executes the processing shown in FIG. 8, triggered by acquisition of the pen touch event. The second application 1200A, having acquired the pen touch event, first generates image data in which a dot is drawn at the coordinates shown by the acquired first data (step SB1). The second application 1200A sends the generated image data to the operating system 1000A (step SB2). The operating system 1000A writes the image data sent from the second application 1200A to the buffer 105A. Also, the second application 1200A issues an update command that instructs updating of display (step SB3). The operating system 1000A, upon acquiring the update command, sends the acquired update command to the drive unit 106A. When the drive unit 106A receives the update command and drives the display unit 107A based on the data written to the buffer 105A, a dot is drawn at the position where the stylus pen PE is in contact.

The sensor 103A outputs first data and second data whose content is “in contact” when the user moves the stylus pen PE in contact with the display surface, at the timing at which the sensor 103A next detects the coordinates of the stylus pen PE. The operating system 1000A acquires the second data and the first data output by the sensor 103A. The operating system 1000A, upon acquiring the second data whose content is “in contact”, issues a pen move event and sends the issued pen move event and the acquired first data to the second application 1200A, in the case where the content of the second data acquired immediately before the acquired second data is “in contact”.

The second application 1200A, upon acquiring the pen move event (YES at step SB4), generates image data of a line connecting the coordinates of the newly acquired first data and the coordinates of the first data acquired immediately before the newly acquired first data (step SB5). The second application 1200A sends the generated image data to the operating system 1000A (step SB6). The operating system 1000A writes the image data sent from the second application 1200A to the buffer 105A. Also, the second application 1200A issues an update command that instructs updating of display (step SB7). The operating system 1000A, upon acquiring the update command, sends the acquired update command to the drive unit 106A. When the drive unit 106A receives the update command and drives the display unit 107A based on the data written to the buffer 105A, a line corresponding to the movement locus of the stylus pen PE is displayed on the display unit 107A. Thereafter, the second application 1200A executes the processing from step SB5 whenever a pen move event is issued, until a pen release event is issued. An example in which the user has drawn a line with the stylus pen PE is shown in FIG. 9. When the user moves the stylus pen PE on the display surface, a line L1 is displayed as illustrated in FIG. 9.

Next, when the user removes the stylus pen PE that was in contact with the display surface from the display surface, the sensor 103A outputs second data whose content is “not in contact”. The operating system 1000A acquires the second data output by the sensor 103A. The operating system 1000A, upon acquiring the second data whose content is “not in contact”, issues a pen release event and sends the issued pen release event to the second application 1200A, in the case where the content of the second data acquired immediately before the acquired second data is “in contact”.

When the pen release event is acquired (YES at step SB8), the second application 1200A, in the case where the synchronization mode is ON (YES at step SB9), issues a second synchronization instruction that instructs display synchronization and includes the IP address of the display apparatus 10A, the document filename of the displayed document, the page number of the displayed document and the first data (coordinate data for one stroke of the stylus pen PE) acquired between the pen touch event and the pen release event to the first application 1100A (step SB10). Note that one line drawn with the stylus pen PE, that is, the movement of the stylus pen PE from a pen touch event to a pen release event, is one stroke. The first application 1100A acquires the second synchronization instruction issued by the second application 1200A, and sends the acquired second synchronization instruction to the operating system 1000A. The operating system 1000A controls the communication unit 108A to transmit the second synchronization instruction sent from the first application 1100A to the server apparatus 20.

When the communication unit 208 receives the second synchronization instruction transmitted from the display apparatus 10A, the control unit 200 acquires the second synchronization instruction received by the communication unit 208. In the case where the IP address included in the acquired second synchronization instruction is included in the list stored in the storage unit 202, the control unit 200 specifies IP addresses other than the IP address of the display apparatus 10A that transmitted the second synchronization instruction among the IP addresses included in the list. The control unit 200 controls the communication unit 208 and transfers the acquired second synchronization instruction to the display apparatuses 10 having the specified IP addresses. Note that, in the present embodiment, the second synchronization instruction is transferred to the display apparatuses 10B and 10C.

When the communication unit 108B receives the second synchronization instruction transferred by the server apparatus 20, the operating system 1000B sends the second synchronization instruction received by the communication unit 108B to the first application 1100B. The first application 1100B acquires the second synchronization instruction, and sends the acquired second synchronization instruction to the second application 1200B. The second application 1200B acquires the second synchronization instruction sent from the first application 1100B. Note that in the case where the operating system of the display apparatuses 10 is Android®, the second application 1200B utilizes the bind mechanism, and the second synchronization instruction is acquired from the first application 1100B by call-back without passing via the operating system 1000B.

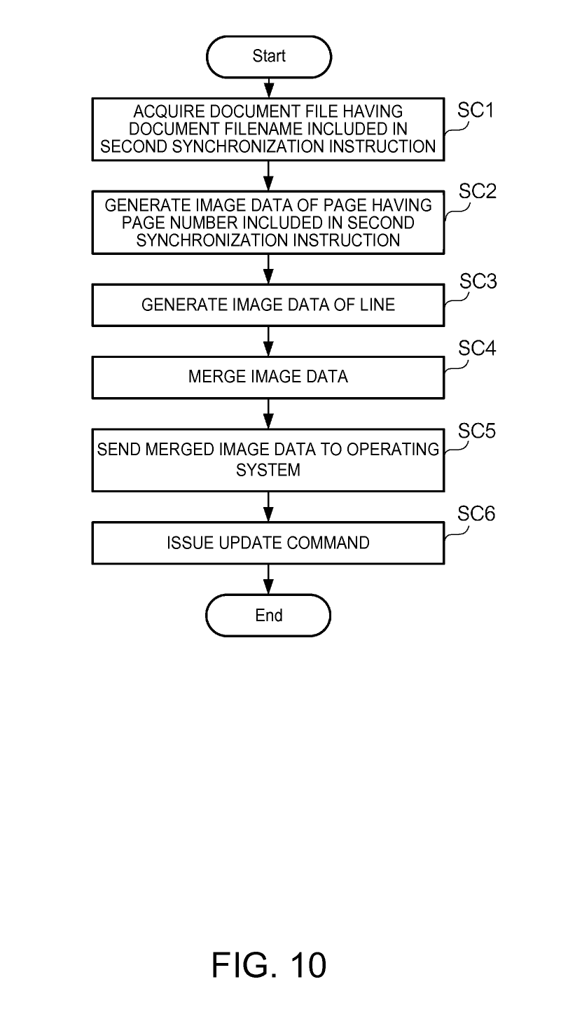

The second application 1200B executes the processing shown in FIG. 10 when the second synchronization instruction is acquired. First, the second application 1200B acquires the document file having the document filename included in the second synchronization instruction from the storage unit 102B (step SC1). The second application 1200B specifies, in the acquired document file, the page having the page number included in the second synchronization instruction, and generates image data of the specified page (step SC2). Also, the second application 1200B generates image data of a line connecting the coordinates of the first data, based on the first data included in the second synchronization instruction (step SC3). The second application 1200B merges the image data of the page and the image data of the line (step SC4), and sends the merged image data to the operating system 1000B (step SC5). Note that the second application 1200B generates data showing the line connecting the coordinates of the first data, and adds the generated data to the document file of the displayed document.

Note that the line connecting coordinates is not limited to a line connecting the coordinates linearly, and may be a revised line such as a line interpolated based on the coordinates of the first data.

The operating system 1000B writes the image data sent from the second application 1200A to the buffer 105B. Also, the second application 1200B issues an update command that instructs updating of display (step SC6). The operating system 1000B, upon acquiring the update command, sends the acquired update command to the drive unit 106B. When the drive unit 106B receives the update command and drives the display unit 107B based on the data written to the buffer 105B, the same document and handwritten line as the document and handwritten line displayed in the display apparatus 10A are displayed on the display unit 107B.

Similar operations to the display apparatus 10B are also performed in the display apparatus 10C when the communication unit 108C receives the second synchronization instruction, and the same document and handwritten line as the document and handwritten line displayed in the display apparatus 10A are displayed on the display unit 107C.

Note that since the second application 1200A does not issue the second synchronization instruction in the case where the synchronization mode is OFF in the display apparatus 10A, the same screen as the display apparatus 10A is not displayed in the display apparatuses 10B and 10C.

Exemplary Operations when an Operation for Changing the Displayed Page is Performed

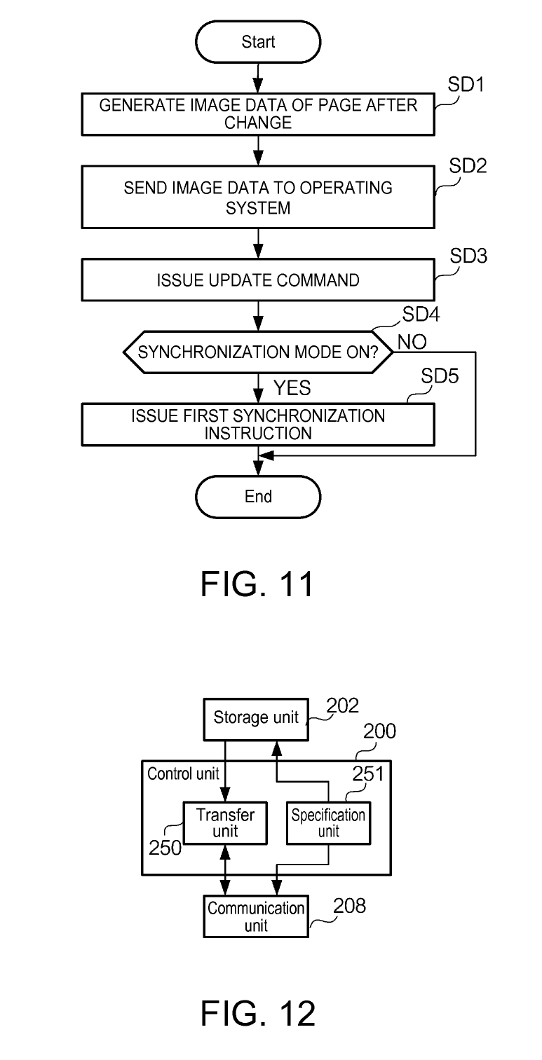

Next, exemplary operations in the case where the user performs an operation for proceeding to a subsequent page or returning to a previous page of the displayed document will be described. FIG. 11 is a flowchart showing the flow of processing that is performed by the second application 1200, when the user performs an operation for proceeding to a subsequent page or returning to a previous page of a document. When the user performs an operation for proceeding to a subsequent page or returning to a previous page of the displayed document on the operation unit 101A, the second application 1200A generates image data of the page after the change (step SD1), and sends the generated image data to the operating system 1000A (step SD2). The operating system 1000A writes the image data sent from the second application 1200A to the buffer 105A. Also, the second application 1200A sends an image update command to the operating system 1000A (step SD3). The operating system 1000A, upon acquiring the update command, sends the acquired update command to the drive unit 106A. When the drive unit 106A receives the update command and drives the display unit 107A based on the data written to the buffer 105A, the page after the change is displayed.

After issuing the update command, the second application 1200A, in the case where the synchronization mode is ON (YES at step SD4), issues a first synchronization instruction that instructs screen synchronization and includes the IP address of the display apparatus 10A, the document filename of the displayed document, and the page number of the displayed document to the first application 1100A (step SD5). The first application 1100A acquires the first synchronization instruction issued by the second application 1200A, and sends the acquired first synchronization instruction to the operating system 1000A. The operating system 1000A controls the communication unit 108A to transmit the first synchronization instruction sent from the first application 1100A to the server apparatus 20.

When the communication unit 208 receives the first synchronization instruction transmitted from the display apparatus 10A, the control unit 200 acquires the first synchronization instruction received by the communication unit 208. In the case where the IP address included in the acquired second synchronization instruction is included in the list stored in the storage unit 202, the control unit 200 specifies IP addresses other than the IP address of the display apparatus 10A that transmitted the first synchronization instruction among the IP addresses included in the list. The control unit 200 controls the communication unit 208 and transfers the acquired first synchronization instruction to the display apparatuses 10 having the specified IP addresses. Note that, in the present embodiment, the first synchronization instruction is transferred to the display apparatuses 10B and 10C.

When the communication unit 108B receives the first synchronization instruction transferred by the server apparatus 20, the operating system 1000B sends the first synchronization instruction received by the communication unit 108B to the first application 1100B. The first application 1100B acquires the first synchronization instruction, and sends the acquired first synchronization instruction to the second application 1200B via the operating system 1000B. Note that in the case where the operating system of the display apparatus 10 is Android®, the first application 1100B designates the second application 1200B by explicit intent and sends the acquired first synchronization instruction to the second application 1200B via the operating system 1000B, but a configuration may be adopted in which the first application 1100B sends the acquired first synchronization instruction to the second application 1200B via the operating system 1000B by implicit intent. The second application 1200B acquires the first synchronization instruction sent via the operating system 1000B from the first application 1100B.

The second application 1200B executes the processing shown in FIG. 7 when the first synchronization instruction is acquired. The second application 1200B, upon acquiring the first synchronization instruction, acquires the document file having the document filename included in the first synchronization instruction from the storage unit 102B (step SA1). The second application 1200B specifies, in the acquired document file, the page having the page number included in the first synchronization instruction, and generates image data of the specified page (step SA2).

The second application 1200B sends the generated image data to the operating system 1000B (step SA3). The operating system 1000B writes the image data sent from the second application 1200A to the buffer 105B. Also, the second application 1200B issues an update command that instructs updating of display (step SA4). The operating system 1000B, upon acquiring the update command, sends the acquired update command to the drive unit 106B. When the drive unit 106B receives the update command and drives the display unit 107B based on the data written to the buffer 105B, the same page as the page displayed in the display apparatus 10A is displayed on the display unit 107B.

Similar operations to the display apparatus 10B are also performed in the display apparatus 10C when the communication unit 108C receives the first synchronization instruction, and the same page as the page displayed in the display apparatus 10A is displayed on the display unit 107C.

Note that since the second application 1200A does not issue the first synchronization instruction in the case where the synchronization mode is OFF in the display apparatus 10A, the same screen as the display apparatus 10A is not displayed in the display apparatuses 10B and 10C.

As described above, the same screen as the screen displayed in one display apparatus 10 is also displayed in other display apparatuses 10 according to the present embodiment, thus enabling the same screen to be shared by a plurality of display apparatuses 10. Note that since the display apparatuses 10A to 10C have the same configuration, it is possible, in the case where an operation on a page or an addition of a handwritten line is performed in the display apparatus 10B, for the same screen as the screen displayed in the display apparatus 10B to be displayed in the display apparatuses 10A and 10C. Also, it is possible, in the case where an operation on a page or an addition of a handwritten line is performed in the display apparatus 10C, for the same screen as the screen displayed in the display apparatus 10C to be displayed in the display apparatuses 10A and 10B.

### Modifications

Although an embodiment of the invention has been described above, the invention is not limited to the abovementioned embodiment and can be implemented in various other forms. For example, the invention may be implemented by modifying the abovementioned embodiment as follows. Note that the abovementioned embodiment and the following modifications may be respectively combined with each other.

In the abovementioned embodiment, the display apparatus 10 is configured to accept the first synchronization instruction and the second synchronization instruction transferred from the server apparatus 20 in the case where the synchronization mode is OFF, but may be configured not to accept the first synchronization instruction or the second synchronization instruction transferred from the server apparatus 20 in the case where the synchronization mode is OFF.

In the abovementioned embodiment, the server apparatus 20 may be configured to periodically search for display apparatuses 10 in the display system 1, and update the list stored in the storage unit 202 with the IP addresses of display apparatuses 10 found in the search. For example, the server apparatus 20 prestores the IP addresses of display apparatuses 10 that are capable of performing communication with the server apparatus 20. In addition to the transfer unit 250, the server apparatus 20 is provided with a specification unit 251 that specifies display apparatuses 10 that are capable of communicating with the server apparatus 20, as shown in FIG. 12. This specification unit 251 transmits a request for requesting a response to the display apparatuses 10 whose IP addresses are stored, and registers the IP addresses of the display apparatuses 10 that return a response in the list in the storage unit 102. According to this configuration, transmission of synchronization instructions can be limited to only display apparatuses 10 that are cable of communicating with the server apparatus 20.

In the abovementioned embodiment, a configuration may be adopted in which the first synchronization instruction includes the data (object data) of each handwritten line, in the case where a plurality of handwritten lines are added as objects to the page to be displayed. In this case, a display apparatus 10, having acquired the first synchronization instruction, generates the image data of objects based on the object data included in the first synchronization instruction, and merges the generated image data of the objects with the image data of the page to be displayed. Note that the data that is included in the first synchronization instruction is not limited to the data of handwritten lines, and may include the data of other objects such as underlines and strikethroughs of character strings, for example.

In the abovementioned embodiment, the second synchronization instruction is configured to include the coordinate data for one stroke, but is not limited to this configuration. For example, a configuration may be adopted in which the second synchronization instruction is transmitted, whenever any of a pen touch event, a pen move event and a pen release event occurs. In this configuration, the display apparatus 10 includes data instructing the start of drawing and the coordinates (first data) of the stylus pen PE in the second synchronization instruction, in the case where a pen touch event occurs. A display apparatus 10, having received this second synchronization instruction, starts processing for drawing a line, and displays an image of a dot at the coordinates shown by the first data included in the second synchronization instruction. Also, in the case where a pen move event occurs after the pen touch event, the display apparatus 10 includes the coordinates (first data) of the stylus pen PE and data instructing the drawing of a line in the second synchronization instruction. The display apparatus 10, having received this second synchronization instruction, displays an image of a line connecting the coordinates of the newly acquired first data and the coordinates of the first data acquired immediately before the newly acquired first data. Also, the display apparatus 10 includes data instructing the end of drawing of the line in the second synchronization instruction, in the case where a pen release event occurs after the pen move event. The display apparatus 10, having received this second synchronization instruction, ends the processing for drawing the line displayed based on the second synchronization instruction transmitted according to the pen touch event and the second synchronization instruction transmitted according to the pen move event.

In the abovementioned embodiment, a handwritten line is drawn in the display apparatuses 10B and 10C after the drawing of one stroke by the display apparatus 10A has ended, whereas according to this configuration, a line corresponding to the movement locus over which the stylus pen PE is moved is also displayed in the display apparatuses 10B and 10C when the stylus pen PE is moving on the display surface of the display apparatus 10A. Although the communication load increases, the display in the display apparatus 10A can be reproduced in a state more closely approximating real-time in the display apparatuses 10B and 10C.

In the abovementioned embodiment, the server apparatus 20 selectively transmits various synchronization instructions (first synchronization instruction, second synchronization instruction) to display apparatuses 10 other than the transmission origin of the synchronization instructions, but may be configured to also transmit the synchronization instructions to the display apparatus 10 that is the transmission origin. Note that, in this configuration, a display apparatus 10 that has acquired the synchronization instructions may, in the case where the IP address of the display apparatus 10 is included in the acquired first and second synchronization instructions, be configured to discard the acquired synchronization instructions without operating in accordance therewith.

With this embodiment, the processing load of the server apparatus 20 can be reduced.

In the abovementioned embodiment, a configuration may be adopted in which, in the case where a display apparatus 10 that has acquired the synchronization instructions does not store the document file having the document filename included in the synchronization instructions, the display apparatus 10 that does not store the document file downloads the document file from the server apparatus 20.

Specifically, the server apparatus 20 stores document files uploaded from the display apparatuses 10. In the case where a display apparatus 10 that has acquired the synchronization instructions does not store a document file having the document filename included in the synchronization instructions, the display apparatus 10 requests the server apparatus 20 for the document file having the document filename included in the synchronization instructions. The server apparatus 20, in the case where the requested document file is stored, transmits the requested document file to the display apparatus 10 that requested the document file.

In the present embodiment, it is not necessary to prestore the same document files in all the display apparatuses 10 before distributing the display apparatuses to individual users.

Also, the configuration in which the display apparatuses 10 download document files from the server apparatus 20 may be configured as described hereinafter. In this modification, when the user performs an operation for uploading a document file, for example, the second application 1200A issues a third synchronization instruction including the IP address of the display apparatus 10A, and the filename of the document file to the first application 1100A. The first application 1100A, upon acquiring the third synchronization instruction, uploads the document file having the filename included in the third synchronization instruction to the server apparatus 20. The server apparatus 20, upon storing the document file uploaded from the display apparatus 10A, transmits a message notifying that uploading was completed to the display apparatus 10A. In the display apparatus 10A, upon receipt of this message, the first application 1100A sends the third synchronization instruction to the operating system 1000A, and the operating system 1000A controls the communication unit 108A to transmit the third synchronization instruction to the server apparatus 20.

The server apparatus 20 transfers the third synchronization instruction transmitted from the display apparatus 10A to the display apparatuses 10B and 10C. In the display apparatuses 10B and 10C, the transferred third synchronization instruction is sent from the operating system 1000 to the first application 1100. The first application 1100 downloads the document file having the filename included in the third synchronization instruction from the server apparatus 20. When downloading of the document file has ended, the first application 1100 sends the third synchronization instruction to the second application 1200 via the operating system 1000B. The second application 1200 acquires the document file having the filename included in the third synchronization instruction from the storage unit 102, and generates image data of the acquired document file. The second application 1200 sends the generated image data to the operating system 1000. The operating system 1000 writes the image data sent from the second application 1200 to the buffer 105. Also, the second application 1200 issues an update command that instructs updating of display. The operating system 1000, upon acquiring the update command, sends the acquired update command to the drive unit 106. When the drive unit 106 receives the update command and drives the display unit 107 based on the data written to the buffer 105, the same page as the page displayed in the display apparatus 10A is displayed on the display units 107B and 107C.

In the abovementioned embodiment, a configuration may be adopted in which the synchronization mode is set to ON when a document file is opened in a display apparatus 10, and the display apparatus 10 that opened the document file transmits the first synchronization instruction to the server apparatus 20.

In the abovementioned embodiment, the page numbers that are included in the synchronization instructions are page numbers counted from the head of the document, but a configuration may be adopted in which, for example, a page that is to serve as a reference is set in the document, and relative page numbers counted from the set page are included in the synchronization instructions.

In the abovementioned embodiment, document filenames are included in the synchronization instructions as identifiers showing documents to be displayed, but the identifiers showing documents to be displayed are not limited to document filenames, and may be anything that uniquely identifies document files in a plurality of display apparatuses 10. For example, in the display system 1, a number is allocated for each document file, and the number allocated to the document file is included in the synchronization instruction as an identifier showing the document to be displayed.

In the abovementioned embodiment, the coordinates of the stylus pen PE are detected by the sensor 103 that is provided in the display apparatus 10, but the configuration for detecting the coordinates of the stylus pen PE is not limited to this configuration. For example, the coordinates of the stylus pen PE on the display surface or whether or not the stylus pen PE is in contact with the display surface may be detected by the stylus pen PE, and the first data and the second data may be transmitted from the stylus pen PE to the display apparatus 10.

In the abovementioned embodiment, the server apparatus 20 transfers the synchronization instructions to display apparatuses 10 having the IP addresses in the list in storage unit 202, but the configuration for transferring synchronization instructions to the display apparatus 10 is not limited to this configuration. For example, a function called Comet that is used in chat applications may be realized in the server apparatus 20, and synchronization instructions may be transferred to the display apparatus 10 using this function. Specifically, each display apparatus sends a request for requesting synchronization instructions to the server apparatus 20. The server apparatus 20, upon receipt of a request from a display apparatus 10, suspends a response to the request. When synchronization instructions are sent from a display apparatus 10, the server apparatus 20 cancels suspension of a response, and transmits the synchronization instructions to the client that transmitted the request.

Computer programs that are executed by the display apparatus 10 may be installed from a state of being stored on a computer-readable recording medium such as a magnetic recording medium (magnetic tape, magnetic disk (HDD (Hard Disk Drive), FD (Flexible Disk)), etc.), an optical recording medium (optical disc etc.), a magneto-optical recording medium, or a semiconductor memory. The computer programs may also be installed by being downloaded via a communication line.

This application claims priority from Japanese Patent Application No. 2014-031471 filed in the Japanese Patent Office on Feb. 21, 2014, the entire disclosure of which is hereby incorporated by reference in its entirely.

What is claimed is:

1. A display system comprising:
a server apparatus; and
a plurality of display apparatuses,
each of the plurality of display apparatuses including:
a display unit that displays an image;
a storage unit that stores a document;
a transmission unit that transmits a synchronization instruction including an identifier of a document that is displayed on the display unit to the server apparatus;
a reception unit that receives a synchronization instruction transmitted from the server apparatus; and
a display control unit that acquires, from the storage unit, a document that is specified by an identifier included in the synchronization instruction received by the reception unit, and controls the display unit such the acquired document is displayed, and
the server apparatus including:
a transfer unit that receives the synchronization instruction transmitted from the transmission unit, and transmits the received synchronization instruction to at least display apparatuses other than the display apparatus that transmitted the synchronization instruction.

2. The display system according to claim 1,
wherein the synchronization instruction includes an apparatus identifier that identifies the plurality of display apparatuses, and
the display control unit does not control the display unit, in a case where the apparatus identifier included in the synchronization instruction received by the reception unit is the apparatus identifier of the display apparatus in which the display control unit is included.

3. The display system according to claim 1,
wherein the server apparatus includes a specification unit that requests the plurality of display apparatuses for a response, and specifies a display apparatus that returns a response to the request, and
the transfer unit transmits the synchronization instruction to the display apparatus specified by the specification unit.

4. The display system according to claim 1,
wherein the display apparatus includes a detection unit that detects coordinates indicated by an indicator that indicates coordinates on a display surface of the display unit,
the transmission unit transmits a synchronization instruction including the coordinates detected by the detection unit to the server apparatus, and
the display control unit controls the display such that a line generated based on the coordinates included in the synchronization instruction is displayed.

5. The display system according to claim 4,
wherein the synchronization instruction includes the coordinates for one stroke of the indicator.

6. The display system according to claim 4,
wherein the synchronization instruction includes information showing a start of one stroke or information showing an end of one stroke, and
the display control unit controls the display such that a line connecting the coordinates included in the synchronization instruction is displayed, based on the synchronization instruction including the information showing the start of one stroke, the synchronization instruction received by the reception unit after the synchronization instruction showing the start of one stroke, and the synchronization instruction including the information showing the end of one stroke.

7. The display system according to claim 1,
wherein the transmission unit transmits a synchronization instruction including object data showing an object to be displayed on the display unit, and
the display control unit controls the display such that an image of the object that is shown by the object data included in the synchronization instruction is displayed.

8. The display system according to claim 1,
wherein the transmission unit transmits a synchronization instruction including a page number of the document, and
the display control unit controls the display such that a page having the page number included in the synchronization instruction, out of the acquired document, is displayed.

9. The display system according to claim 8,
wherein the display control unit is an application,
the synchronization instruction includes identification information showing the application, and
the synchronization instruction that is received by the reception unit is sent to the application corresponding to the identification information included in the synchronization instruction via an operating system.

10. The display system according to claim 4,
wherein the synchronization instruction including the coordinates that is received by the reception unit is sent to the display control unit without passing via an operating system.

11. A display apparatus comprising:
a display unit that displays an image;
a storage unit that stores a document;
a transmission unit that transmits a synchronization instruction including an identifier of a document that is displayed on the display unit to a server apparatus;
a reception unit that receives a synchronization instruction transmitted from the server apparatus; and
a display control unit that acquires, from the storage unit, a document that is specified by an identifier included in the synchronization instruction received by the reception unit, and controls the display unit such the acquired document is displayed.

12. A computer program for causing a computer to execute:
a transmission step of transmitting a synchronization instruction including an identifier of a document that is displayed on a display unit to a server apparatus;
a reception step of receiving a synchronization instruction transmitted from the server apparatus; and
a transfer step of sending the synchronization instruction to an application that is specified by identification information included in the synchronization instruction received in the reception step.
